(19) United States
(12) Patent Application Publication
(10) Pub. No.: US 2015/0100988 A1
(43) Pub. Date: Apr. 9, 2015

(54) Method of Selection and Management of Resources

(71) Applicant: InfoPower Corporation, Taipei (TW)

(72) Inventors: Jer-Bin Lin, New Taipei City (TW); Che-Yu Lee, New Taipei City (TW); Chun-Lin Chen, Tainan City (TW)

(73) Assignee: InfoPower Corporation, Taipei (TW)

(21) Appl. No.: 14/049,124

(22) Filed: Oct. 8, 2013

(51) Int. Cl. H04N 21/482; H04N 21/24

(52) U.S. Cl. CPC H04N 21/482; H04N 21/24
USPC 725/54

(57) ABSTRACT

For selection of publicly accessible resources from a backend server and the management of the resources on a mobile device, a resource management program is installed on the mobile device. The resource management program is able to link the mobile device to a backend server so as to download a plurality of channels. And through the resource management program, a user may select at least one program from a plurality of programs downloaded from the backend server and save it onto a personally accessible memory of the mobile device.

### BACKGROUND OF THE INVENTION

1. Field of the Invention

The present invention relates to a method of selection and management of resources, and more particularly, a method of selection and management of resources for downloading a plurality of resources from a publicly accessible memory and saving at least one resource of the plurality of resources to a personally accessible memory.

2. Description of the Prior Art

There are a growing number of uses for mobile devices such as smart phones and tablets. One of the more popular uses of the said devices is viewing of resources from the internet. There is a need for management of the said resources for user convenience.

An example of such application is a BBC news app, where the content of the BBC news site is categorized and displayed on the mobile device. The contents are regularly updated as the content of the BBC news site is updated. The categories help the user to select resources that are of interest to them more easily. However, the BBC news app only organizes resource from a single source. Moreover, the content of the BBC news site cannot be stored in the mobile device, limiting the BBC news app to a very small set of functionalities.

### SUMMARY OF THE INVENTION

An embodiment of the present invention discloses a method of selection and management of resources. The method comprises installing and running a resource management program on a mobile device; displaying a plurality of categories, a plurality of sub-categories of one of the categories, and thumbnails of contents of the sub-categories stored on a personally accessible memory on a user interface of the resource management program; linking the mobile device to a backend server; downloading a plurality of channels from a publicly accessible memory of the backend server to the mobile device after linking the mobile device to the backend server; after selecting a channel from the plurality of channels, downloading at least one program of the channel and a plurality of contents associated with the at least one program from the publicly accessible memory of the backend server to the mobile device; and displaying the at least one program of the channel and thumbnails of the contents associated with the at least one program on the user interface.

Another embodiment of the present invention discloses a method of selection and management of resources. The method comprises installing and running a resource management program on a mobile device; displaying a plurality of categories stored on a personally accessible memory on a private domain of a user interface of the resource management program; linking the mobile device to a backend server; downloading a plurality of channels from a publicly accessible memory to the mobile device after linking the mobile device to the backend server; after selecting a channel from the plurality of channels, downloading a plurality of programs of the channel and a plurality of contents associated with the plurality of programs from the publicly accessible memory of the backend server to the mobile device; and displaying the plurality of programs of the channel and thumbnails of the contents associated with the plurality of programs on a public domain of the user interface.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 illustrates a private domain interface of a user interface of a resource management program on a mobile device according to a first embodiment of the present invention.

FIG. 2 illustrates a public domain interface of the user interface of the resource management program on the mobile device according to a second embodiment of the present invention.

FIG. 3 illustrates the public domain interface with a sidebar corresponding to contents of the private domain interface of the user interface of the resource management program on a mobile device according to a third embodiment of the present invention.

FIG. 4 is a flowchart of the method of selection and management of resources for downloading and saving of resources from a publicly accessible memory of a backend server according to the present invention.

FIG. 5 is a flowchart of the method of selection and management of resources for subscribing of resources from a publicly accessible memory of a backend server according to the present invention.

### DETAILED DESCRIPTION

For enhancing convenience of selection and managing of resources, the present invention discloses a method of selection and management of resources. Note that the mobile device may be a smart pad or a smart phone in the embodiments of the present invention.

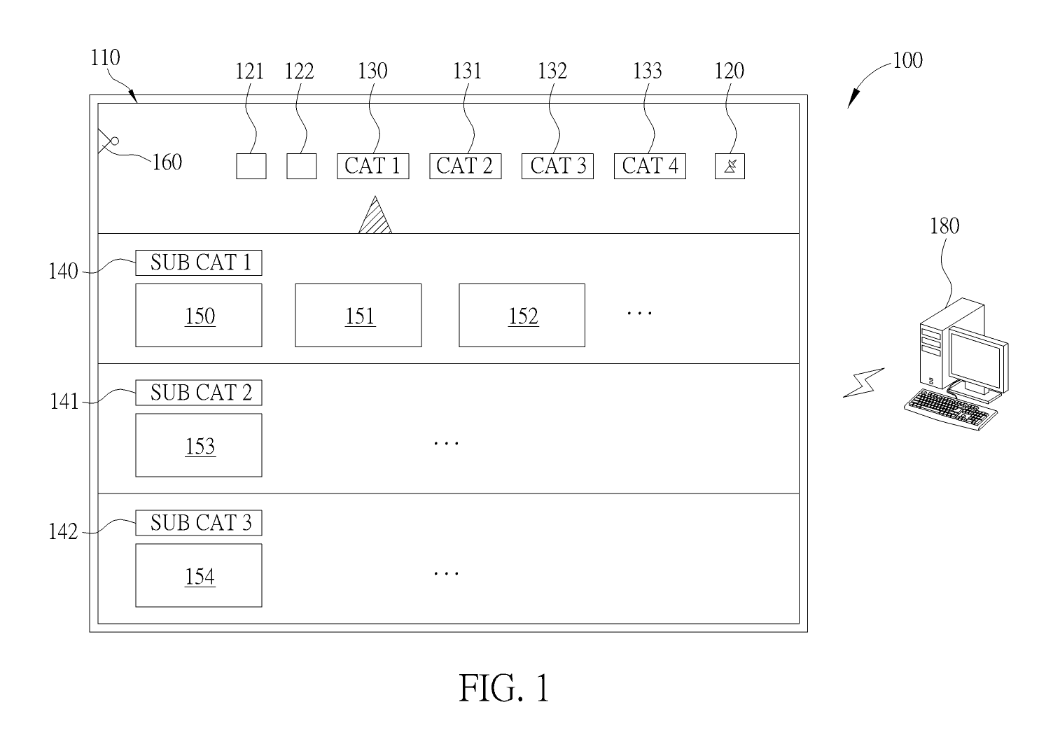

Please refer to FIG. 1. FIG. 1 illustrates a private domain interface of a user interface 110 of a resource management program on a mobile device 100 according to a first embodiment of the present invention. The user interface 110 comprises of a plurality of icons 120 to 122, a plurality of categories 130 to 133, a plurality of sub-categories 140 to 142, thumbnails 150 to 154 of contents of the sub-categories 140 to 142 stored on a personally accessible memory. The personally accessible memory is a memory of the mobile device and/or a personal cloud memory, that is, any memory only accessible by the mobile device 100. The resource management program does not limit the number of categories. A category comprises at least one sub-category having at least one content.

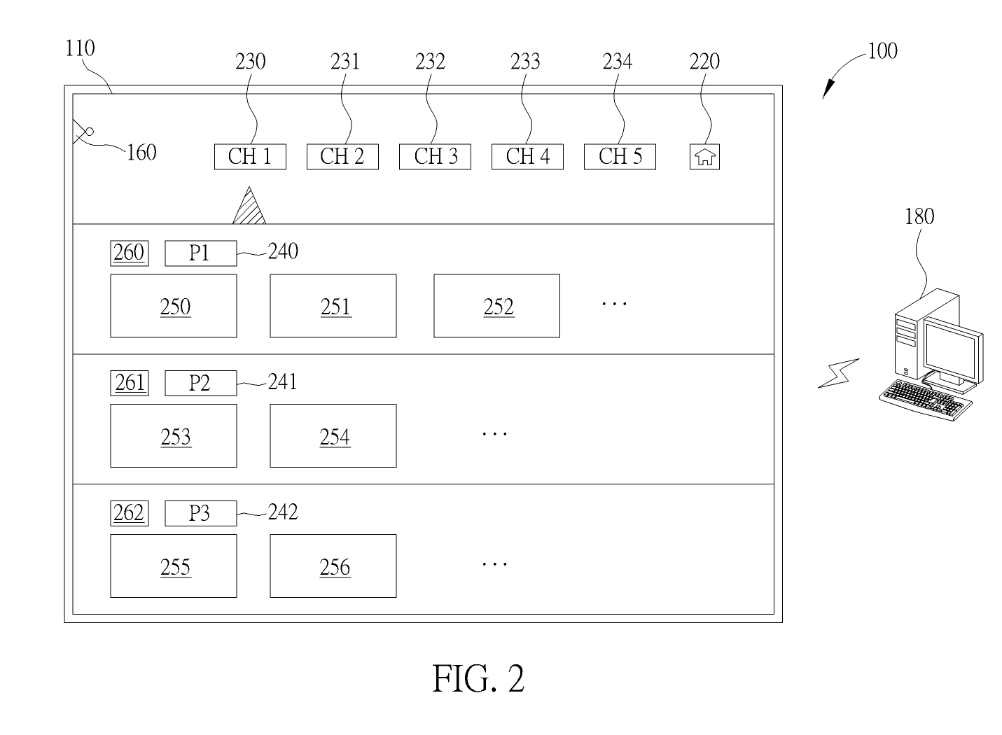

Each of the plurality of icons corresponds to a command to be executed by the resource management program. One of the plurality of icons is a link icon 120. When the link icon 120 is selected, it will link the mobile device 100 to a backend server 180. When the mobile device 100 is linked to the backend server 180, the mobile device 100 will download a plurality of channels from a publicly accessible memory of the backend server 180 to the mobile device 100. Please refer to FIG. 2. FIG. 2 illustrates a public domain interface of the user interface 110 of the resource management program on the mobile device 100 according to a second embodiment of the present invention. The user interface 110 comprises of at least one icon 220, a plurality of channels 230 to 234, a plurality of programs 240 to 242, thumbnails 250 to 256 of contents of the programs 240 to 242, and select icons 260 to 262. One of the at least one icon 220 is a return icon that can be selected if the user wants to go back to the private domain interface of the user interface 110.

The user can select a channel from a plurality of channels. The resource management program downloads at least one program of the channel and a plurality of contents associated with the at least one program from the publicly accessible memory of the backend server 180 to the mobile device 100. The user interface 110 then displays the at least one program of the channel and thumbnails of the contents associated with the at least one program.

As shown in FIG. 2, beside the plurality of programs 240 to 242 are the select icons 260 to 262. Each select icon corresponds to a program, i.e., the select icon 260 corresponds to the program 240, the select icon 261 corresponds to the program 241, and the select icon 262 corresponds to the program 242.

The user selects at least one program from the plurality of programs by selecting the select icon(s) corresponding to the at least one program.

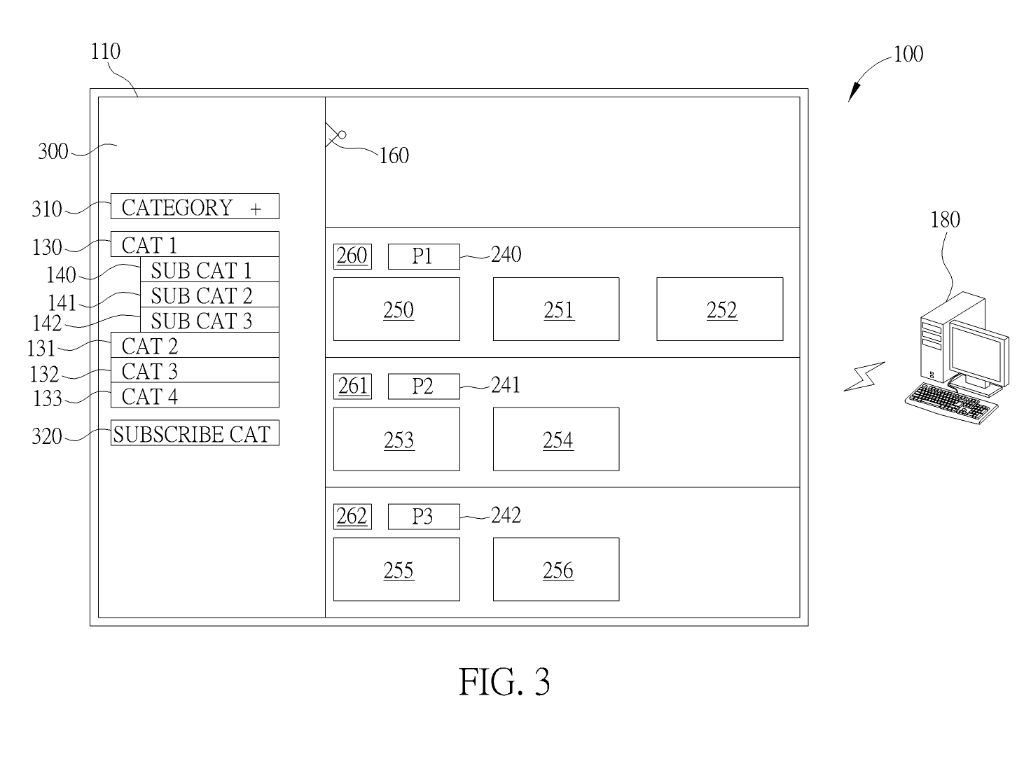

Please refer to FIG. 3. FIG. 3 illustrates the public domain interface with a sidebar 300 corresponding to contents of the private domain interface of the user interface 110 of the resource management program on the mobile device 100 according to a third embodiment of the present invention. The user interface 110 from FIG. 3 comprises of the plurality of programs 240 to 242, the thumbnails 250 to 256 of contents of the programs 240 to 242, the select icons 260 to 262, and the sidebar 300.

The sidebar 300 is shown on the user interface 110 when a tag icon 160 that is present in all embodiments of the present invention as shown in FIG. 1, FIG. 2, and FIG. 3 dragged towards the center of the user interface 110. The sidebar 300 comprises of an add category option 310, the plurality of categories 130 to 133, the plurality of sub-categories 140 to 142, and a subscribe category 320.

The user selects at least one program from the public domain by selecting the select icon(s) corresponding to the at least one program. The user adds the at least one program selected from the public domain to at least one category selected from the plurality of categories 130 to 133 in the private domain by performing drag and drop with the selected at least one program from the public domain. The adding of the at least one program to the at least one category allows the mobile device 100 to save current contents of the at least one program and view the at least one program even after the at least one program has been removed from the backend server 180.

The user is also able to add a new category on the private domain by using the add category option 310. When clicking the add category option 310, a new category is created and the user is asked to input a name for the new category. After the new category is created, the user can add at least one program selected from the public domain to the new category of the private domain by performing drag and drop with the selected at least one program from the public domain.

By performing the drag and drop with the selected at least one program from the public domain on to the add category option 310, the resource management program will be able to create a new category automatically. The naming of the new category can be taken from general description of the selected at least one program, i.e., article title, downloaded date, or source.

If a program selected from the public domain has already been added to the private domain before, the resource management program can optionally generate a warning message and terminate adding of the program selected from the public domain to a category of the plurality of categories 130 to 133 or the new category of the private domain. The resource management program can also allow a single program to be added to different categories.

The user can also add the at least one program selected from the public domain to the subscribe category 320 in the private domain by performing drag and drop with the selected at least one program from the public domain. The adding of the at least one program to the subscribe category 320 enables the mobile device 100 to subscribe the at least one program and allows the mobile device 100 to update the at least one program every time the backend server 180 updates the at least one program.

If a program selected from the public domain has already been added to the private domain before, the resource management program can optionally generate a warning message and terminate adding of the program selected from the public domain to a subscribe category 320 of the private domain.

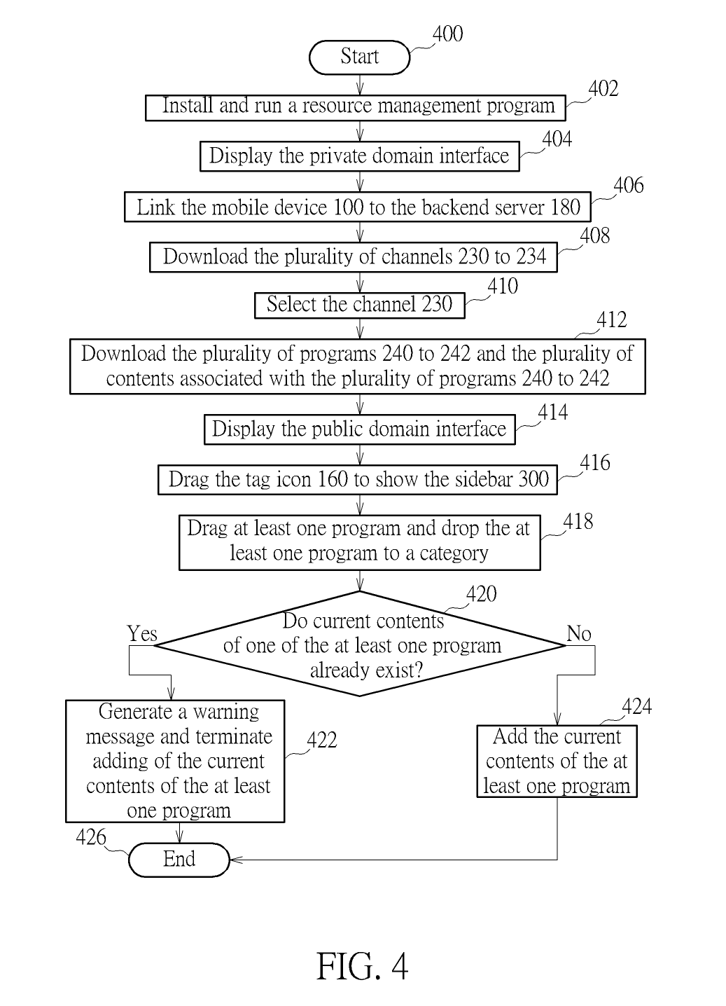

Please refer to FIG. 4, which is a flowchart of the method of selection and management of resources for downloading and saving of resources from a publicly accessible memory of a backend server according to the present invention. As shown in FIG. 4, the method of select and management of resources may include and is not limited to the following steps:

Step 400: start;

Step 402: install and run a resource management program on the mobile device 100;

Step 404: display the plurality of icons 120 to 122, the plurality of categories 130 to 134, the plurality of sub-categories 140 to 142 of the category 130, and the thumbnails 150 to 154 of contents of the plurality of sub-categories 140 to 142 stored on the personally accessible memory on the private domain interface of the user interface 110 of the resource management program;

Step 406: link the mobile device 100 to the backend server 180 by selecting the link icon 120;

Step 408: download the plurality of channels 230 to 234 from the publicly accessible memory of the backend server 180 to the mobile device 100 after linking the mobile device 100 to the backend server 180;

Step 410: select the channel 230 from the plurality of channels 230 to 234;

Step 412: download the plurality of programs 240 to 242 of the channel 230 and the plurality of contents associated with the plurality of programs 240 to 242 from the publicly accessible memory of the backend server 180 to the mobile device 100;

Step 414: display the plurality of programs 240 to 242 of the channel 230 and thumbnails 250 to 256 of the contents associated with the plurality of programs 240 to 242 on the public domain interface of the user interface 110;

Step 416: drag the tag icon 160 towards the center of the user interface 110 to show the sidebar 300 comprising of the add category option 310, the plurality of categories 130 to 133, the plurality of sub-categories 140 to 142, and a subscribe category 320;

Step 418: drag at least one program of the plurality of programs 240 to 242 and drop the at least one program to a category of the plurality of categories 130 to 133 or a new category;

Step 420: does one of current contents of the at least one program already exist on one of the plurality of categories 130 to 133? If so, go to Step 422; else perform Step 424;

Step 422: the resource management program generates a warning message and terminates adding of one of the current contents of the at least one program selected from the public domain interface to the category from a plurality of category 130 to 133 or the new category of the private domain interface; go to Step 426;

Step 424: add the current contents of the at least one program to the category of the plurality of categories 130 to 133 or the new category;

Step 426: end.

Step 416 can be optionally omitted. In this case, when at least one program is dragged for a predetermined period of time, the sidebar 300 comprising of the add category option 310, the plurality of categories 130 to 133, the plurality of sub-categories 140 to 142, and the subscribe category 320 will be shown to allow Step 418 to be performed.

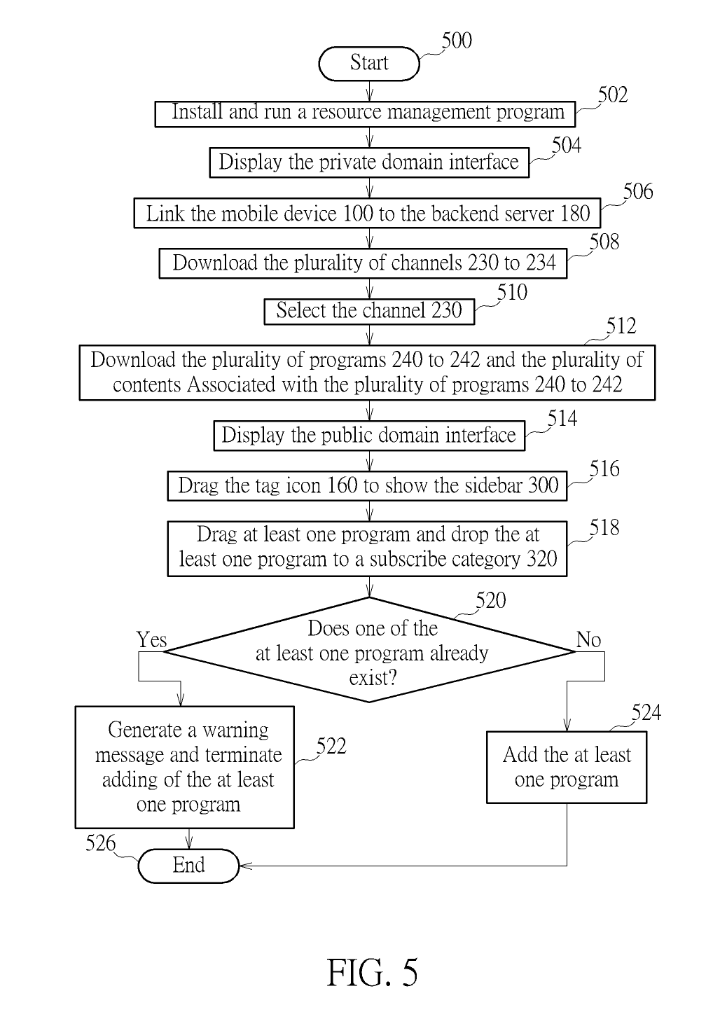

Please refer to FIG. 5, which is a flowchart of the method of selection and management of resources for subscribing of resources from a publicly accessible memory of a backend server according to the present invention. As shown in FIG. 5, the method of select and management of resources may include and is not limited to the following steps:

Step 500: start;

Step 502: install and run a resource management program on the mobile device 100;

Step 504: display the plurality of icons 120 to 122, the plurality of categories 130 to 134, the plurality of sub-categories 140 to 142 of the category 130, and the thumbnails 150 to 154 of contents of the plurality of sub-categories 140 to 142 stored on the personally accessible memory on the private domain interface of the user interface 110 of the resource management program;

Step 506: link the mobile device 100 to the backend server 180 by selecting the link icon 120;

Step 508: download the plurality of channels 230 to 234 from the publicly accessible memory of the backend server 180 to the mobile device 100 after linking the mobile device 100 to the backend server 180;

Step 510: select the channel 230 from the plurality of channels 230 to 234;

Step 512: download the plurality of programs 240 to 242 of the channel 230 and the plurality of contents associated with the plurality of programs 240 to 242 from the publicly accessible memory of the backend server 180 to the mobile device 100;

Step 514: display the plurality of programs 240 to 242 of the channel 230 and thumbnails 250 to 256 of the contents associated with the plurality of programs 240 to 242 on the public domain interface of the user interface 110;

Step 516: drag the tag icon 160 towards the center of the user interface 110 to show the sidebar 300 comprising of the add category option 310, the plurality of categories 130 to 133, the plurality of sub-categories 140 to 142, and the subscribe category 320;

Step 518: drag at least one program of the plurality of programs 240 to 242 and drop the at least one program to the subscribe category 320;

Step 520: does one of the at least one program already exists on one of the plurality of subscribe category 320? If so, go to Step 522; else perform Step 524;

Step 522: the resource management program generates a warning message and terminates adding of the at least one program selected from the public domain interface to the subscribe category 320 of the private domain interface; go to Step 526;

Step 524: add the at least one program to the subscribe category 320;

Step 526: end.

Step 516 can be optionally omitted. In this case, when at least one program is dragged for a predetermined period of time, the sidebar 300 comprising of the add category option 310, the plurality of categories 130 to 133, the plurality of sub-categories 140 to 142, and the subscribe category 320 will be shown to allow Step 518 to be performed.

The backend server 180 mentioned in the present invention is able to collect a plurality of channels from a plurality of sources. Each of the channels may contain a plurality of programs. Each of the programs may contain a plurality of contents. The channels, programs and contents are shown in the public domain interface of the user interface 110. The channels may include news, coupon, image, document, advertisement, article, survey, questionnaire and/or sports. The plurality of programs may be a subset of a channel, i.e., CNN, NBC and BBC for news, STAR and ESPN for sports, and Groupon and Amazon for coupon. The plurality of channels, programs and/or contents downloaded from the backend server 180 can be personalized according to a profile of the user, i.e, gender, age, occupation and country, and a plurality of settings, i.e., parental guidance rating, set by the user. For instance, if the profile of the user indicates that the user is under 18, channels, programs and/or contents with age restrictions may not be downloaded to the mobile device 100 by the resource management program. After at least one program has been subscribed by the user, the at least one program is regularly updated whenever the mobile device 100 links to the backend server 180. Further, at least one of the contents from the plurality of contents under a program can be selected and saved under a sub-category of a category or a new sub-category created under the category of the private domain interface. This will allow the user to view the content even when the program has already been updated and the content is no longer available from the backend server 180. The user also has the option to repeatedly save contents of a program that already exist in the privately accessible memory under a category preferred by the user.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A method of selection and management of resources, comprising:
installing and running a resource management program on a mobile device;
displaying a plurality of categories, a plurality of sub-categories of one of the categories, and thumbnails of contents of the plurality of sub-categories stored on a personally accessible memory on a user interface of the resource management program;
linking the mobile device to a backend server;
downloading a plurality of channels from a publicly accessible memory of the backend server to the mobile device after linking the mobile device to the backend server;
after selecting a channel from the plurality of channels, downloading at least one program of the channel and a plurality of contents associated with the at least one program from the publicly accessible memory of the backend server to the mobile device; and
displaying the at least one program of the channel and thumbnails of the contents associated with the at least one program on the user interface.

2. The method of claim 1 wherein the personally accessible memory is a memory of the mobile device and/or a personal cloud memory.

3. The method of claim 1 wherein when displaying the at least one program of the channel and thumbnails of the contents associated with the at least one program on the user interface, the plurality of categories, the plurality of sub-categories of one of the categories, and the thumbnails of contents of the sub-categories are no longer displayed on the user interface.

4. The method of claim 1 wherein downloading the at least one program of the channel and the plurality of contents associated with the at least one program from the publicly accessible memory of the backend server to the mobile device is downloading the at least one program of the channel and the plurality of contents associated with the at least one program from the publicly accessible memory of the backend server to the mobile device according to a profile and/or settings recorded in the resource management program.

5. A method of selection and management of resources, comprising:
installing and running a resource management program on a mobile device;
displaying a plurality of categories stored on a personally accessible memory on a private domain of a user interface of the resource management program;
linking the mobile device to a backend server;
downloading a plurality of channels from a publicly accessible memory to the mobile device after linking the mobile device to the backend server;
after selecting a channel from the plurality of channels, downloading a plurality of programs of the channel and a plurality of contents associated with the plurality of programs from the publicly accessible memory of the backend server to the mobile device; and
displaying the plurality of programs of the channel and thumbnails of the contents associated with the plurality of programs on a public domain of the user interface.

6. The method of claim 5 further comprising adding current contents of at least one program of the plurality of programs to a category of the plurality of categories or a new category.

7. The method of claim 6 wherein adding the current contents of the at least one program of the plurality of programs to the category of the plurality of categories or the new category is performed by selecting the at least one program of the plurality of programs and performing drag and drop to add the current contents of the at least one program to the category or the new category.

8. The method of claim 6 further comprising if the current contents of the at least one program already exist on one of the plurality of categories, generating a warning message.

9. The method of claim 5 further comprising when requested to add current contents of at least one program to a category of the plurality of categories or a new category, if the current contents of the at least one program already exist on one of the plurality of categories, generating a warning message.

10. The method of claim 5 further comprising adding at least one program of the plurality of programs to a subscribe category.

11. The method of claim 10 wherein adding the at least one program of the plurality of programs to the subscribe category comprises selecting the at least one program of the plurality of programs and performing drag and drop to add the at least one program to the subscribe category.

12. The method of claim 10 further comprising if the at least one program already exists on the subscribe category, generating a warning message.

13. The method of claim 10 further comprising updating contents of the at least one program in the subscribe category after linking the mobile device to the backend server.

14. The method of claim 5 further comprising when requested to add at least one program of the plurality of programs to a subscribe category, if the at least one program already exists on the subscribe category, generating a warning message.

15. The method of claim 5 wherein downloading the plurality of programs of the channel and the plurality of contents associated with the plurality of programs from the publicly accessible memory of the backend server to the mobile device is downloading the plurality of programs of the channel and the plurality of contents associated with the plurality of programs from the publicly accessible memory of the backend server to the mobile device according to a profile and/or settings recorded in the resource management program.
